(19) United States
(12) Patent Application Publication
(10) Pub. No.: US 2018/0239392 A1
(43) Pub. Date: Aug. 23, 2018

(54) Multipurpose elastic band

(71) Applicant: James M. Jobin, Henderson, NV (US)

(72) Inventor: James M. Jobin, Henderson, NV (US)

(21) Appl. No.: 15/932,193

(22) Filed: Feb. 16, 2018

Related U.S. Application Data
(60) Provisional application No. 62/459,859, filed on Feb. 16, 2017.

(51) Int. Cl. G06F 1/16

(52) U.S. Cl. CPC G06F 1/1607

(57) ABSTRACT

A multipurpose elastic band to wrap around an object, the multipurpose elastic band including a main portion to elastically stretch around the object, and a protruded portion disposed along an entire base of the main portion to protrude a predetermined distance perpendicularly from the main portion and to elastically stretch along with the main portion.

### CROSS REFERENCE TO RELATED APPLICATIONS

This application claims the benefit of U.S. Provisional Patent Application No. 62/459,859, filed Feb. 16, 2017 and entitled “STRETCHABLE BAND WITH BEVEL FOR SECURING NOTES TO A MONITOR,” the entire disclosure of which is incorporated herein by reference.

### BACKGROUND

### 1. Field

The present general inventive concept relates generally to an elastic band, and more particularly, to a multipurpose elastic band.

### 2. Description of the Related Art

The computer flat screen monitor, laptop, notebook and tablet computer have become the primary focus of today's high-tech workers to perform every aspect of their jobs. Computers run a myriad of commercial programs ranging from graphics design, financial, and word processing to custom programs that interface directly to the corporate mainframe and have unique key-board combinations and “quick-reference” Function Keys that perform as Hot-Keys to “jump” a user directly to a specific module of the company system such as “Alt-SH-F5” “jumps” a user to Billing/Invoicing and “Alt-SH-F7” is a hot-key sequence that will “jump” a user to the Sales database.

“TO-DO LISTS”, calendars and other quick-reference materials are currently being adhered to a monitor or laptop using tape or Post-It Notes that quickly become dog-eared, rolled-up and unsightly on a computer. They also quickly lose their adhesion and dislodge from the computer altogether. Adhesive build-up from tape can also render computer hardware “cruddy-looking”.

Therefore, there is a need for an improved device for securing notes to a monitor.

### SUMMARY

The present general inventive concept provides a multipurpose elastic band.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a multipurpose elastic band to wrap around an object, the multipurpose elastic band including a main portion to elastically stretch around the object, and a protruded portion disposed along an entire base of the main portion to protrude a predetermined distance perpendicularly from the main portion and to elastically stretch along with the main portion.

The multipurpose elastic band may further include a beveled surface disposed between the main portion and the protruded portion to be formed when the multipurpose elastic band is pressed against a surface of the object.

The protruded portion may prevent a business card from falling when the business card is disposed between the main portion and a surface of the object.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a perspective view of a multipurpose elastic band, according to an exemplary embodiment of the present general inventive concept;

FIG. 2A illustrates a side view of the multipurpose elastic band, according to an exemplary embodiment of the present general inventive concept;

FIG. 2B illustrates a side view of the multipurpose elastic band pressed against a surface, according to an exemplary embodiment of the present general inventive concept;

FIG. 3 illustrates a side view of a multipurpose elastic band, according to another exemplary embodiment of the present general inventive concept;

FIG. 4A illustrates a Loomed in view of a multipurpose elastic band including an adjustable member and holes, according to another exemplary embodiment of the present general inventive concept;

FIG. 4B illustrates a zoomed in angled view of the adjustable member, according to another exemplary embodiment of the present general inventive concept;

FIG. 5A illustrates a textured inner surface of a multipurpose elastic band, according to another exemplary embodiment of the present general inventive concept;

FIG. 5B illustrates a side view of the textured inner surface of FIG. 5A, according to another exemplary embodiment of the present general inventive concept;

FIG. 5C illustrates a zoomed-in side view of one textured member of the textured inner surface of FIG. 5A, according to another exemplary embodiment of the present general inventive concept;

FIG. 6A illustrates a textured inner surface of a multipurpose elastic band, according to another exemplary embodiment of the present general inventive concept;

FIG. 6B illustrates a side view of the textured inner surface of FIG. 6A, according to another exemplary embodiment of the present general inventive concept;

FIG. 6C illustrates a zoomed-in side view of one textured member of the textured inner surface of FIG. 6A, according to another exemplary embodiment of the present general inventive concept;

FIG. 7A illustrates a textured inner surface of a multipurpose elastic band, according to another exemplary embodiment of the present general inventive concept;

FIG. 7B illustrates a side view of the textured inner surface of FIG. 7A, according to another exemplary embodiment of the present general inventive concept;

FIG. 7C illustrates a zoomed-in side view of one textured member of the textured inner surface of FIG. 7A, according to another exemplary embodiment of the present general inventive concept;

FIG. 8A illustrates a textured inner surface of a multipurpose elastic band, according to another exemplary embodiment of the present general inventive concept;

FIG. 8B illustrates a side view of the textured inner surface of FIG. 8A, according to another exemplary embodiment of the present general inventive concept;

FIG. 8C illustrates a zoomed-in side view of one textured member of the textured inner surface of FIG. 8A, according to another exemplary embodiment of the present general inventive concept;

FIG. 9A illustrates a textured inner surface of a multipurpose elastic band, according to another exemplary embodiment of the present general inventive concept;

FIG. 9B illustrates a side view of the textured inner surface of FIG. 9A, according to another exemplary embodiment of the present general inventive concept;

FIG. 9C illustrates a zoomed-in side view of one textured member of the textured inner surface of FIG. 9A, according to another exemplary embodiment of the present general inventive concept;

FIG. 10A illustrates a textured inner surface of a multipurpose elastic band, according to another exemplary embodiment of the present general inventive concept;

FIG. 10B illustrates a side view of the textured inner surface of FIG. 10A, according to another exemplary embodiment of the present general inventive concept;

FIG. 10C illustrates a zoomed-in side view of one textured member of the textured inner surface of FIG. 10A, according to another exemplary embodiment of the present general inventive concept;

FIG. 11A illustrates a textured inner surface of a multipurpose elastic band, according to another exemplary embodiment of the present general inventive concept;

FIG. 11B illustrates a side view of the textured inner surface of FIG. 11A, according to another exemplary embodiment of the present general inventive concept;

FIG. 11C illustrates a zoomed-in side view of one textured member of the textured inner surface of FIG. 11A, according to another exemplary embodiment of the present general inventive concept;

FIG. 12A illustrates a textured inner surface of a multipurpose elastic band, according to another exemplary embodiment of the present general inventive concept; and

FIG. 12B illustrates a side view of the textured inner surface of FIG. 12A, according to another exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

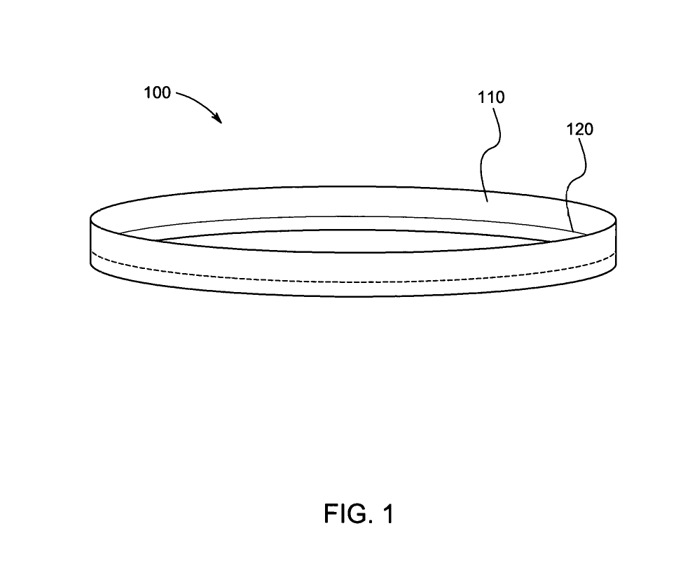

FIG. 1 illustrates a perspective view of a multipurpose elastic band 100, according to an exemplary embodiment of the present general inventive concept.

The multipurpose elastic band 100 may include a main portion 110 and a protruded portion 120.

The multipurpose elastic band 100 may be made of an elastic material such as silicone, rubber, or any other stretchable material known to one of ordinary skill in the art.

The multipurpose elastic band 100 may be transparent, semi-transparent, or opaque, and may include any color desired by the user.

The main portion 110 may be stretched along with the protruded portion 120.

The protruded portion 120 may be disposed along an entire base of the main portion 110, and may protrude perpendicularly away from the main portion 110.

In alternative embodiments, a hole may be provided at a center portion of the main portion 110, in order to allow a web camera at a top front surface of a laptop computer to remain uncovered. In other words, the hole may allow the multipurpose elastic band 100 to be wrapped around the top portion of the laptop computer, such that the webcam is still visible as a result of the inclusion of the hole in the main portion 110.

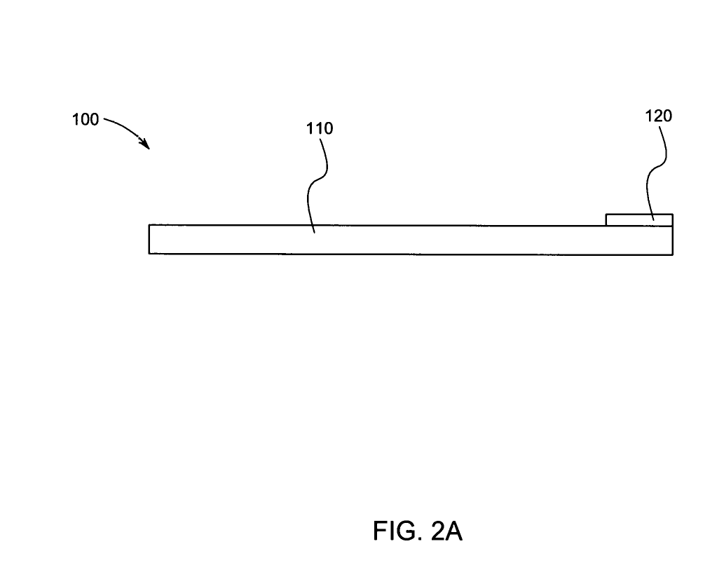

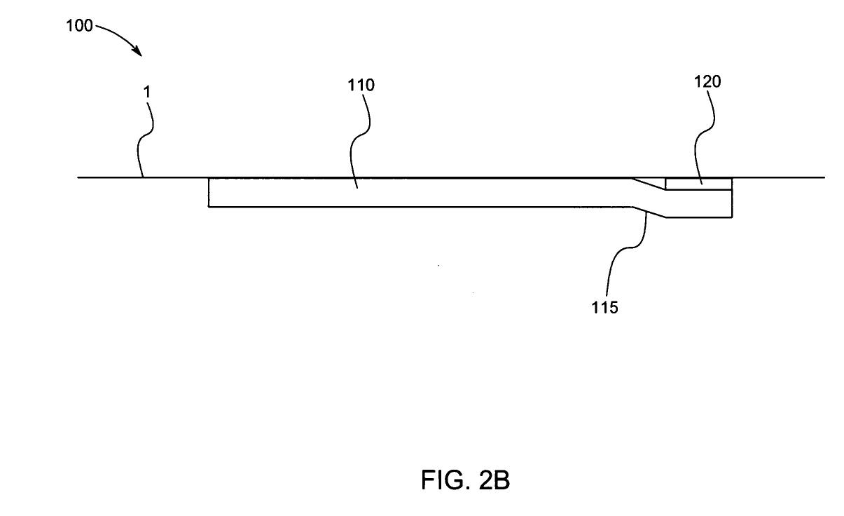

FIG. 2A illustrates a side view of the multipurpose elastic band 100, according to an exemplary embodiment of the present general inventive concept.

Referring to FIG. 2A, it is clear that the protruded portion 120 provides a portion of the multipurpose elastic band 100 that protrudes away from the main portion 110 in a direction perpendicular to a stretching direction of the multipurpose elastic band 100.

FIG. 2B illustrates a side view of the multipurpose elastic band 100 pressed against a surface of an object 1, according to an exemplary embodiment of the present general inventive concept.

Referring to FIG. 2B, when the multipurpose elastic band 100 is wrapped around the surface of the object 1, such as a computer monitor, for example, a beveled surface 115 may be formed between the main portion 110 and the protruded portion 120. This beveled surface 115 of FIG. 2B illustrates that when the multipurpose elastic band 100 is wrapped around the surface of the object 1, both the main portion 110 and the protruded portion 120 are flush in contact with the surface of the object 1, except for the small beveled portion 115 that is formed due to the elastic pressure of the main portion 110 and the protruded portion 120.

As such, if an object such as a business card is disposed between the main portion 110 and the surface of the object 1, the protruded portion 120 may prevent the object from falling.

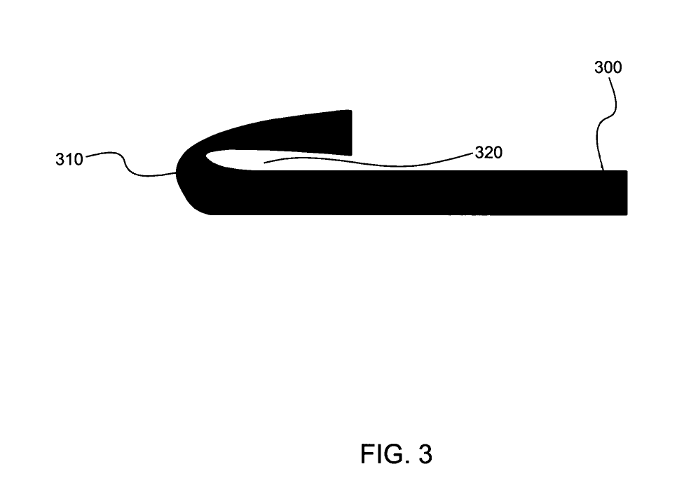

FIG. 3 illustrates a side view of a multipurpose elastic band 300, according to another exemplary embodiment of the present general inventive concept.

Referring to FIG. 3, the multipurpose elastic band 300 may include a bent portion 310 and a pocket 320.

As such, an object such as a business card may be inserted within the pocket 320 to prevent the object from falling when the multipurpose elastic band 300 is pressed against a surface.

The combination of the bent portion 310 and the pocket 320 of the multipurpose elastic band 300 may form a “J” shape, and may be referred to as a J-loop or J-hook, but is not limited thereto.

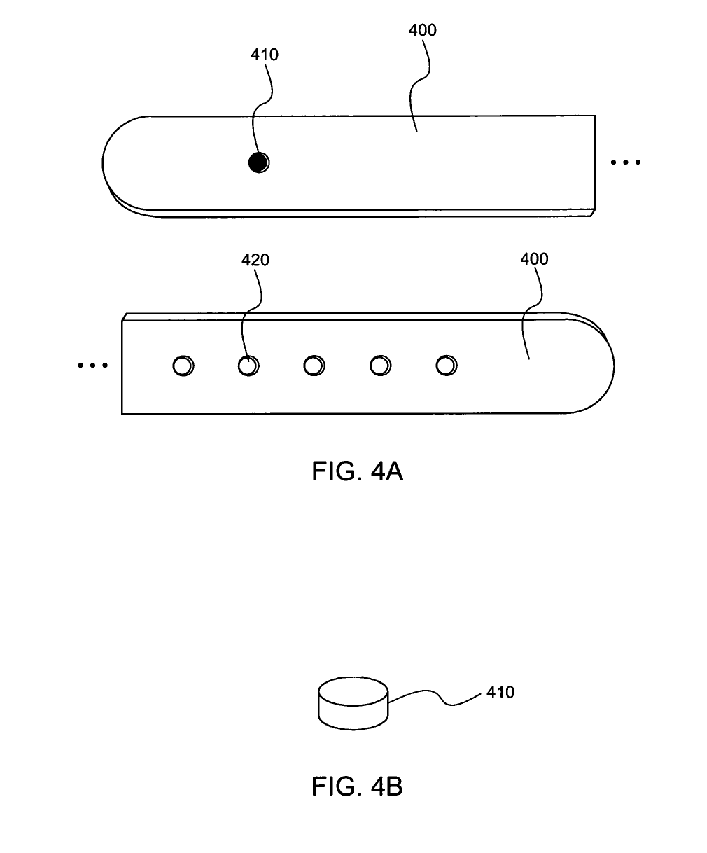

FIG. 4A illustrates a zoomed in view of a multipurpose elastic band 400 including an adjustable member 410 and holes 420, according to another exemplary embodiment of the present general inventive concept.

FIG. 4B illustrates a zoomed in angled view of the adjustable member 410, according to another exemplary embodiment of the present general inventive concept.

Referring to FIGS. 4A and 4B, in order to add extra adjustability properties, when the multipurpose elastic band 400 is wrapped around a surface, the adjustable member 410 at a first end of the multipurpose elastic band 400 may be inserted into and secured within one of the holes 420 disposed at a second end of the multipurpose elastic band 400.

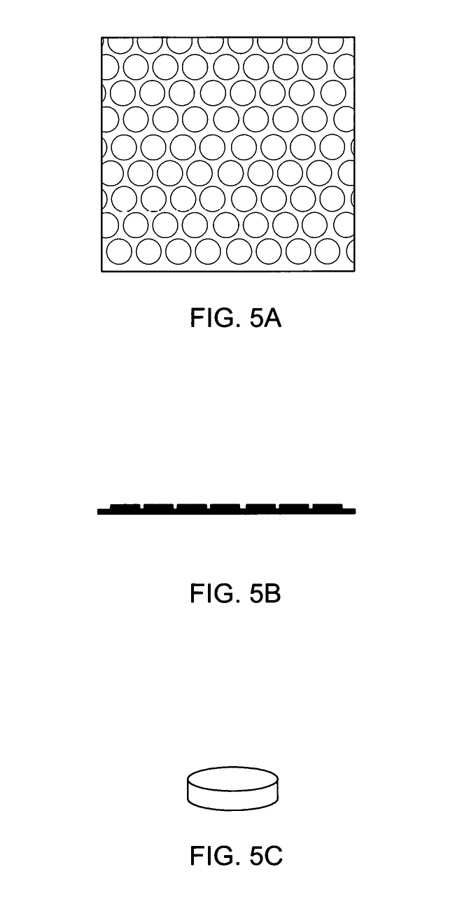

FIGS. 5A through 12B illustrate that inner surfaces of the multipurpose elastic band 100 may have various and different types of textures.

FIG. 5A illustrates a textured inner surface of a multipurpose elastic band, according to another exemplary embodiment of the present general inventive concept.

FIG. 5B illustrates a side view of the textured inner surface of FIG. 5A, according to another exemplary embodiment of the present general inventive concept.

FIG. 5C illustrates a zoomed-in side view of one textured member of the textured inner surface of FIG. 5A, according to another exemplary embodiment of the present general inventive concept.

Referring to FIGS. 5A through 5C, the textured surface may include a plurality of large rounded nibs.

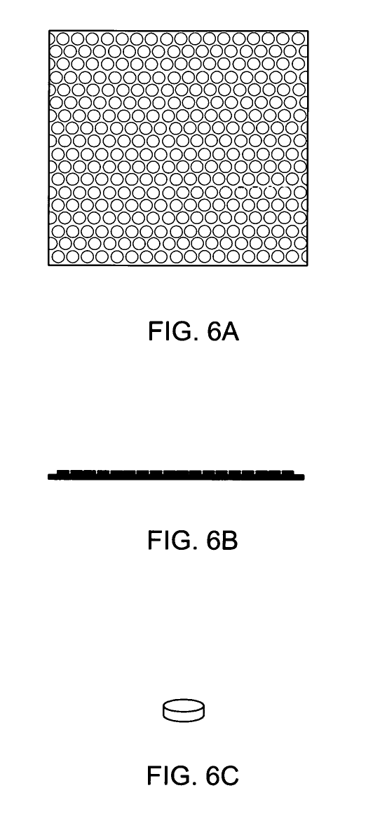

FIG. 6A illustrates a textured inner surface of a multipurpose elastic band, according to another exemplary embodiment of the present general inventive concept.

FIG. 6B illustrates a side view of the textured inner surface of FIG. 6A, according to another exemplary embodiment of the present general inventive concept.

FIG. 6C illustrates a zoomed-in side view of one textured member of the textured inner surface of FIG. 6A, according to another exemplary embodiment of the present general inventive concept.

Referring to FIGS. 6A through 6C, the textured surface may include a plurality of small rounded nibs.

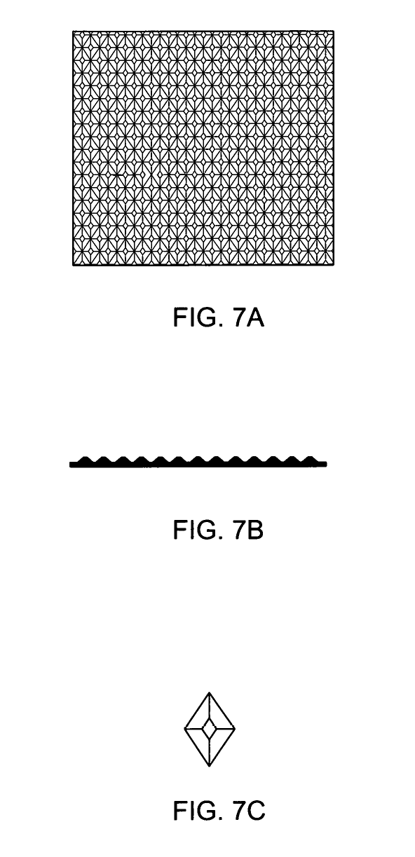

FIG. 7A illustrates a textured inner surface of a multipurpose elastic band, according to another exemplary embodiment of the present general inventive concept.

FIG. 7B illustrates a side view of the textured inner surface of FIG. 7A, according to another exemplary embodiment of the present general inventive concept.

FIG. 7C illustrates a zoomed-in side view of one textured member of the textured inner surface of FIG. 7A, according to another exemplary embodiment of the present general inventive concept.

Referring to FIGS. 7A through 7C, the textured surface may include a plurality of diamond-shaped nibs.

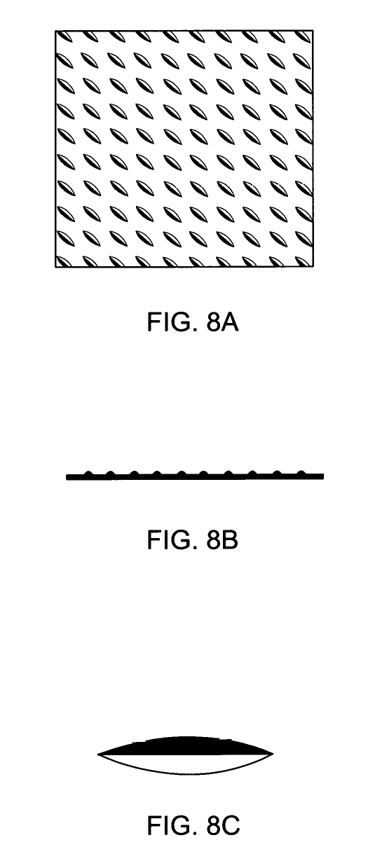

FIG. 8A illustrates a textured inner surface of a multipurpose elastic band, according to another exemplary embodiment of the present general inventive concept.

FIG. 8B illustrates a side view of the textured inner surface of FIG. 8A, according to another exemplary embodiment of the present general inventive concept.

FIG. 8C illustrates a zoomed-in side view of one textured member of the textured inner surface of FIG. 8A, according to another exemplary embodiment of the present general inventive concept.

Referring to FIGS. 8A through 8C, the textured surface may include a plurality of cigar-shaped beveled nibs.

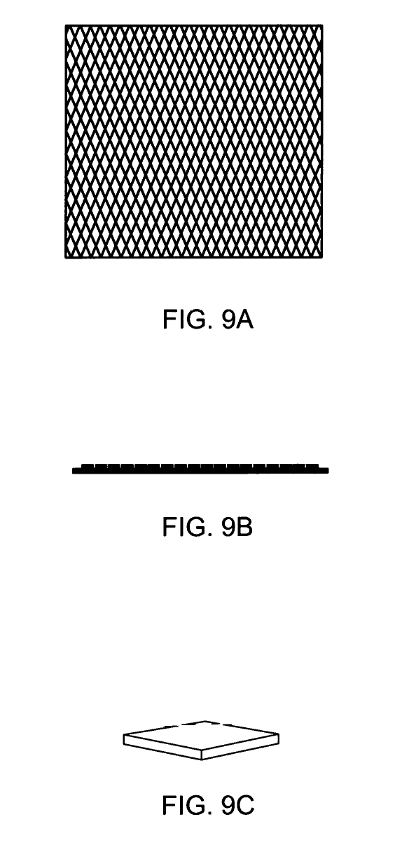

FIG. 9A illustrates a textured inner surface of a multipurpose elastic band, according to another exemplary embodiment of the present general inventive concept.

FIG. 9B illustrates a side view of the textured inner surface of FIG. 9A, according to another exemplary embodiment of the present general inventive concept.

FIG. 9C illustrates a zoomed-in side view of one textured member of the textured inner surface of FIG. 9A, according to another exemplary embodiment of the present general inventive concept.

Referring to FIGS. 9A through 9C, the textured surface may include a plurality of rectangular nibs.

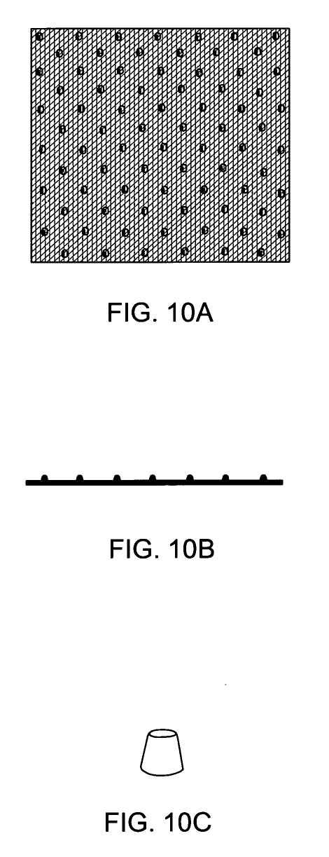

FIG. 10A illustrates a textured inner surface of a multipurpose elastic band, according to another exemplary embodiment of the present general inventive concept.

FIG. 10B illustrates a side view of the textured inner surface of FIG. 10A, according to another exemplary embodiment of the present general inventive concept.

FIG. 10C illustrates a zoomed-in side view of one textured member of the textured inner surface of FIG. 10A, according to another exemplary embodiment of the present general inventive concept.

Referring to FIGS. 10A through 10C, the textured surface may include a plurality of round pyramidal nibs.

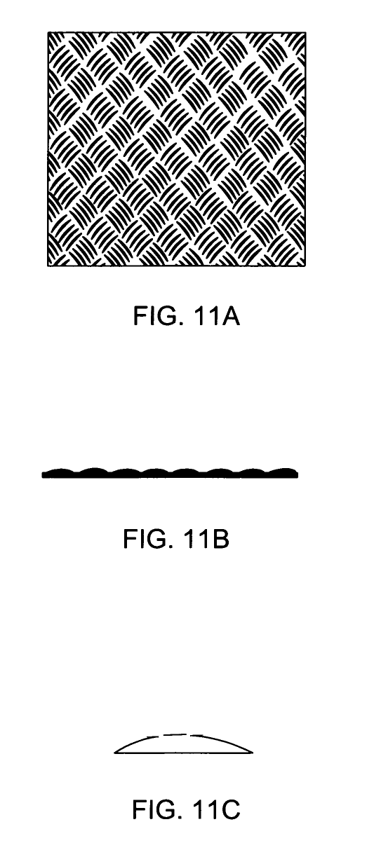

FIG. 11A illustrates a textured inner surface of a multipurpose elastic band, according to another exemplary embodiment of the present general inventive concept.

FIG. 11B illustrates a side view of the textured inner surface of FIG. 11A, according to another exemplary embodiment of the present general inventive concept.

FIG. 11C illustrates a zoomed-in side view of one textured member of the textured inner surface of FIG. 11A, according to another exemplary embodiment of the present general inventive concept.

Referring to FIGS. 11A through 11C, the textured surface may include a plurality of crescent moon shaped slashes.

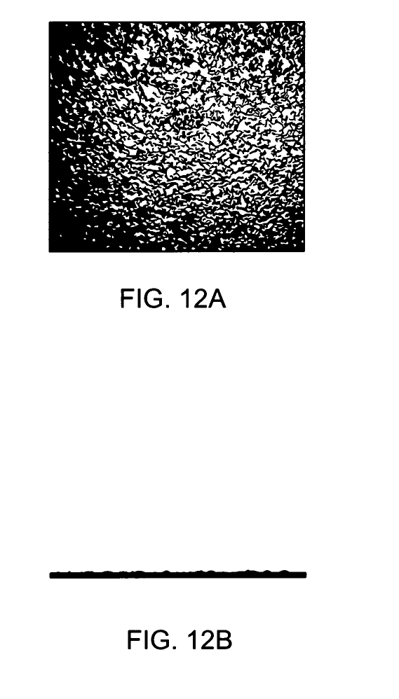

FIG. 12A illustrates a textured inner surface of a multipurpose elastic band, according to another exemplary embodiment of the present general inventive concept.

FIG. 12B illustrates a side view of the textured inner surface of FIG. 12A, according to another exemplary embodiment of the present general inventive concept.

Referring to FIGS. 12A through 12B, the textured surface may include a random rocky-shaped surface.

The present general inventive concept includes a flexible silicone or rubber band with unique emboss/bevel used to hold notes to computer monitor. The present general inventive concept allows anyone with a computer monitor, laptop/notebook computer, tablet or any flat surface (think clip-board) position quick reference notes horizontally or vertically on their screen. The band may include a protrusion, an emboss, or bevel to prevent items from slipping through the band and allowing items to be positioned at a fixed point at bottom of the band.

The present general inventive concept securers quick-reference materials, such as company specific keyboard command references, Software specific computer keyboard short-cuts for programs like Microsoft Word, Excel, Power Point, gaming or other software specific hotKeys. In addition, Calendar; To-Do List; photo of loved-one, etc. are instantly and directly available right on the computer monitor without the use of messy adhesives and Post-It type notes that do not adhere long and curl up into an unsightly mess.

The present general inventive concept includes a clean, neat organization tool used for quick-reference materials right on a flat-screen computer monitor. The present invention may also provide advertising for those businesses that serve customers at a desk where the back of a computer monitor can be seen. The present general inventive concept provides a neat, clean and adhesive free manner to post reference notes for immediate reference directly to a flat-screen computer monitor.

The present general inventive concept includes a soft-stretch silicone design construction with a unique bevel formed along its entire length. The present general inventive concept may range from about 3″ to 24″ in flat length, which translates to about 6″ to 48″ total circumference. The present general inventive concept may be made of a translucent Soft Stretch Silicone material with the emboss near the bottom of the band running the entire length. This emboss provides the fastening system which prevents thin (paper and business card thickness) items placed into the band from sliding through. The chemistry/composition of the Soft Stretch Silicone allows the present general inventive concept to be stretched in excess of 33 inches and are for use on flat screen LCD/LED Monitors, laptops, tablet and to secure items on to clip boards and other flat surfaces such as easel-based White Boards.

The present general inventive concept is stretched across a flat screen monitor either horizontally or vertically along the edge or frame of the Monitor. The seam, bevel or emboss is down in the horizontal position and pointing outward (away from the screen) in the vertical position. Once the present general inventive concept is in place, quick-reference notes, pictures, calendar and to-do-lists, of various size and thickness can be slid into the top and secured in place by the band. In order for the present general inventive concept to be made, a custom die or mold incorporating the emboss or bevel may be used.

The present general inventive concept may also include the following specifications, but is not limited thereto:

1. 5 to 10-Inch Flat Length×1-Inch width—Transparent Soft Stretch Silicone Band.

2. Top of Band Thickness is about 1.27 mm.

3. Imprintable across entire band. Logo and Text.

4. About 0.75 mm-0.88 mm thick emboss running full length on inside bottom of band. Band thickness is about 1.27 mm. Bottom of Band thickness: about 0.75˜0.88+1.27=2.07 mm.

5. Can stretch to fit large Monitors.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A multipurpose elastic band to wrap around an object, the multipurpose elastic band comprising:
a main portion to elastically stretch around the object; and
a protruded portion disposed along an entire base of the main portion to protrude a predetermined distance perpendicularly from the main portion and to elastically stretch along with the main portion.

2. The multipurpose elastic band of claim 1, further comprising:
a beveled surface disposed between the main portion and the protruded portion to be formed when the multipurpose elastic band is pressed against a surface of the object.

3. The multipurpose elastic band of claim 1, wherein the protruded portion prevents a business card from falling when the business card is disposed between the main portion and a surface of the object.
